(19) United States
(12) Patent Application Publication
(10) Pub. No.: US 2006/0294107 A1
(43) Pub. Date: Dec. 28, 2006

(54) Information system

(76) Inventor: Yakov Feldman, Petrozavodsk (RU)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/168,185

(22) Filed: Jun. 28, 2005

(51) Int. Cl. G06F 17/30

(52) U.S. Cl. 707/10

(57) ABSTRACT

An enterprise information system (EIS) is provided that guarantees affordability, unity and quality for EIS for enterprises with no automated data input. Data are stored as objects. Objects form one Object Tree. Users are objects and their relations in the tree coincide with their relations in the enterprise. Sub-tree of Object Tree starting from the user as a root is his/her responsibility zone. What object can contain (data elements) is defined with type-set and its behavior (what object demonstrates and functions to run on it) is defined with type-center (type) that is an element of the type-set. All types form Inheritance Tree and Including Tree. Including Tree defines how objects could be created. Shortcuts (shadows) are allowed in Object Tree, Inheritance Tree, and Including Tree. In Object Tree they expand viewing zone outside responsibility zone. In Inheritance Tree they describe multiple inheritance. In Including Tree they describe multiple including. Type-center could be changed inside type-set. Union of type-sets of objects of responsibility zone of the user is his/her competence zone. Type-set can be changed only if it does not expand the competence zone. Data elements could be fields, keys and files (pictures or documents). Implementation is based on Open Source technologies.

The invention relates to a unified information system for any enterprise such as companies, universities, governmental agencies, etc., except those that use an automated entry of input data. This invention is related to the invention “Arrangement of Enterprise Information System,” for which an application 2004119564 was filed on 28 Jun. 2004 with the Russian Patent Office. No priority based on the Russian application is claimed for the present application.

### BACKGROUND OF THE INVENTION

Two approaches are possible when an enterprise information system is set up. Upon the first approach, an ideal model of the enterprise is selected. Software is acquired for such an ideal model, and the enterprise is adjusted to the model. The closer to the model the adjustment is made the better the software works. By their nature, systems with the automated entry of input data belong to this first approach. An example of such a system is a supermarket where the main portion of data is entered by bar code readers. The bar code cannot be changed, it is not worth changing bar code readers, and data structures are not changed as well.

Upon the second approach, the enterprise is considered a living organism. With economics changing, the enterprises changes respectively, and the information system follows the changes at the enterprise. Which approach to take is up to its management. The present invention relates to the second approach.

There are three main criteria that have to be taken into consideration in assessing an enterprise information system (EIS).

Affordability. Included here are time and financial expenses for establishing and developing the system, demands to the team qualification, etc. The system is affordable if the demands are low and the expenses are small.

Unity. There is a number of advantages resulting from the unity of the EIS. Firstly, the possibility of all-through analysis of information appears. Secondly, the speed of propagation of information increases substantially. Thirdly, completeness and consistency of data and optimal form of storing the same are easier to arrive at, redundancy can be reduced, etc. Accordingly, the level of information support for management can be substantially enhanced.

Quality. To what extent is the EIS user-friendly and comfortable to work in? Can users help, rather than interfere with, each other? Is interface intuitively clear? How much time does it take from start learning to start working? Who, if anybody, is responsible for data processed? Is the system fast enough to monitor events in real time, or it is day, month, year behind? These features and others closely related constitute what is meant by quality.

The above three criteria generate three problems to be solved simultaneously: how to make the EIS affordable, united, and of high quality.

Complete analogs of the invention are those systems where all the three problems are solved. Only one software product is known to declare this. It is TreeLogy described at http://www.treelogy.com. Detailed analysis of the product, however, shows that it belongs to the above first approach, i.e. especially good for the systems with automated entry of input data, which systems are out of consideration with regard to the present invention.

Partial analogs of the invention are those systems where two out of the three above problems are solved. Among those where unity and affordability are provided, whereas proper quality is not, are for example mainframe-legacy automated control system that have been used up to now at some enterprises. They are affordable since substantial financial resources have already been invested in them. Also, they were designed with unity in view. Based on current standards, however, such systems do not provide proper quality. For example, it may take a lot of time to add a new record into a basic table, whereas a demand to enter an additional field can be rejected by technical support personnel as impracticable in principle. The situation with systems spontaneously emerging at an enterprise where various departments purchase themselves software for fulfilling their local tasks can be viewed as an example of systems that are of proper quality and affordable but not united. And relatively expensive for both purchasing and maintaining system integrating means supplied by big corporations such as Weblogic (of BEA), Websphere (IBM), .NET/BizTalk 2004 (Microsoft), 10 g (Oracle), NetWeaver (SAP) can be viewed as unaffordable according to the above categorization.

### SUMMARY OF THE INVENTION

It is an object of the present invention to provide an affordable and united information system of high quality for an enterprise.

The invention is a specific combination of several technical solutions (and of respective concepts) aimed at achieving the declared goal.

An enterprise information system (EIS) according to the present invention comprises multi-user systems where information is arranged in the form of logically autonomous units (objects) working in a network in accordance with a “client-server” architecture based on file systems or data base management systems (DBMS) or integrated development environment (IDE). The users are those objects, all of the objects form a single Object Tree (ObT), and relations between users in the tree coincide with co-workers' interrelations at the enterprise. The maximal sub-tree of the tree with the user as a root constitute the user's Responsibility zone, and the user can create, change, and delete objects when they are in this zone only.

Content of the object is defined by some set (type-set of the object), whereas the content shown and behavior of the object such as its ability to be implemented as a procedure and to carry out, as this takes place, one of the functions from a certain list is defined by some element of the set (type-center or type), and all the types possible form an Inheritance Tree (InhT). In addition, if there is a “node” B in the tree (tree A), then a data elements list for the type A objects, as well as a list of functions that are implemented by the type A object as a procedure, are initial portions of respective lists of type B objects, and any sub-tree of InhT that includes the root of InhT can be a type set.

All the types form a single Including Tree (IncT), and the user can create a new object of type A under object of type B if and only if (1) the object of type B is in his/her zone of responsibility and (2.1) there is a node A in the IncT B or (2.2) A is of a special type, FOLDER.

The root of the ObT corresponds to a special user responsible for all data in the system (Data Base Administrator) and the development of the system (System Architect) and the type of the object constitute a root of InhT and a root of IncT, and only this user is allowed to change InhT and IncT and their nodes.

For every object (original) in the ObT, there is arranged a shortcut (or shadow), through which all the data of the original object are visible, except special shadow data that are stored in the shadow and replace the data of the original object upon demonstration, and all the functions of the object are realizable. The shadows can be united under an ObT thus creating a new Object and Shadow Tree (ObST), wherein a Responsibility zone is created from an ObT Responsibility zone by adding those shadows, and a user can in his/her Responsibility zone execute or delete shadows or modify shadow data.

A Viewing Tree (ViewT) is made from ObjT as follows: 1) each shadow is replaced by a copy of its original, and 2) connected under each copy are copies of all the descendants of the original in the same order as in the ObT (pseudo-nodes), and the user executes all the functions, sees all the data of the originals of those pseudo-nodes, except for the cases where they are eclipsed by shadow data, and can create shadows of all the originals of the ViewT and connect them to the Responsibility zone of the ObT, a shadow of a shadow of the original being considered a shadow of the original and shadows and pseudo-nodes being shown in the ViewT in a different style such as italic.

A Responsibility zone in the ViewT consists of a Responsibility zone in the ObjT and shadows under its nodes if there are any. User can delete such shadows and change their shadow data. A user's Viewing zone is a maximal sub-tree of ViewT from the user as the root. The user can execute functions in this zone. The user can also take any node of the Viewing zone as an origin to make a shadow and add it under the object in the Responsibility zone. Nothing, however, can be added under shadow. A shadow or pseudo-node made from a shadow or pseudo-node takes origin from the latter. Shadows and pseudo-nodes are marked in the interface in a different style (italic, for example).

A Competence zone is defined as a minimal sub-tree of InhT that includes all type-sets of nodes of the Responsibility zone of the ViewT and user can change type-set or type-center of an object in the Responsibility zone if only it does not expand his/her Competence zone.

Objects are implemented as sets of records in the tables of a relational DBMS in such a way that (a) every type has its own table, a table for the type corresponding to the root of InhT and IncT being OBJECT; (b) every such table has a column for an object number (ID); (c) this column is a primary key of the table; (d) an entry in the tableis related to an object if, and only if, the ID value coincides with this object's number; and (e) in every such table but OBJECT, ID is indicated as a FOREIGN KEY for REFERENCES to OBJECT with a ON DELETE CASCADE feature. It guarantees that the DBMS deletes all the node's data from all the tables when the node is deleted from the OBJECT table.

Type-set of an object is defined by the presence of records with a given ID value in tables. Upon moving node A in InhT under node B in InhT, all such tables corresponding to nodes between B and root get records for all objects with A in the type-set if they have not had such records yet.

Some columns in the tables beside ID are indicated as FOREIGN KEYS for other tables if (a) these are integer fields, (b) these columns reference only to PRIMARY KEYS (that is to ID) without an ON DELETE CASCADE option, so that DBMS does not prevent the object from deleting unless at least one reference to this object exists, and (c) the value of such a key is selected from a drop-down list of all the objects of the type whose table is referenced by the key.

Any object is also provided to contain data elements that are files of any format a client computer can view (is provided with a viewer for), and a user is allowed to load such files to a server or delete them from the server when the object is in his/her responsibility zone.

Some of such files (hereinafter called pictures) are demonstrated contemporaneously with all the data elements of the object, while other files (hereinafter called documents) are demonstrated with one more click only.

The structure of ObT is stored in a column PARENT of the table OBJECT, the structures of IncT and InhT are in fields PARENT and PARENT2, respectively, of the table TYPE. These columns store ID of a parent node, and they are FOREIGN KEYS with reference to the same table with the ON DELETE CASCADE option, which guarantees that upon deleting a node, the DBMS will automatically delete the whole sub-tree under this node.

It is not only in the ObT where shadows are provided but in the IncT and InhT as well. In the IncT, shadows serve for creating new objects of an A type under objects of B, C, D, etc., types. To allow that, shadows of A are put under B, D, etc. Shadows of the InhT allow to describe the case of multiple inheritance of type A from B, C, D, etc., for which shadows of A are put under B, C, D, etc. The shadows are stored in the same tables as their originals (OBJECTS, TYPE), and a special column ID2 (ID22 for InhT) includes 0 if this is not a shadow for this tree, and a nonzero number of the original's node if this is its shadow, a root having no shadows, as well as ID2 (ID22) being a FOREIGN KEY referencing the same table with the ON DELETE CASCADE option to guarantee that after an original has been deleted, all the shadows thereof will be deleted by the DBMS.

Also provided are abstract types that appear in the InhT only, rather than in the IncT, and serve solely for collecting some of InhT nodes under a node-parent, no objects being created and no type tables existing for the abstract types.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates data folder and configuration file;

FIG. 2 shows server and libraries;

FIG. 3 illustrates Object Tree;

FIG. 4 presents Including Tree;

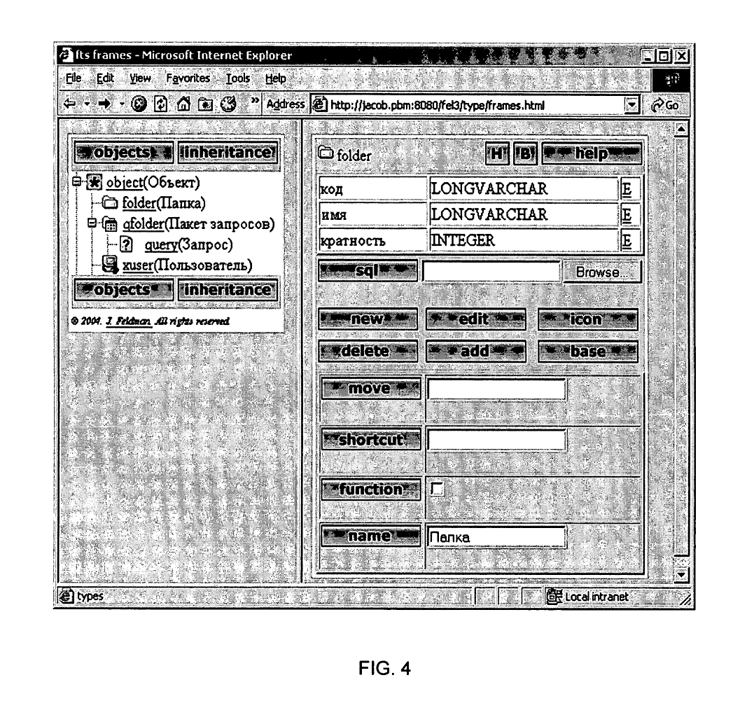

FIG. 5 shows Inheritance Tree;

FIG. 6 illustrates details of interface;

FIG. 7 presents a list of functions;

FIG. 8 illustrates an object for an anonymous user-student, with a point entry;

FIG. 9 shows the same object as in FIG. 8 for a named user, in an edit mode;

FIG. 10 shows the same object as in FIG. 8 for a named user, in a view mode;

FIG. 11 illustrates the same object as in FIG. 8 for an anonymous user-student—package entry;

FIG. 12 presents a package of queries in the Object Tree;

FIG. 13 illustrates the same query package as in FIG. 12 for an anonymous user (analyst entry), with the first analysis result shown on the right;

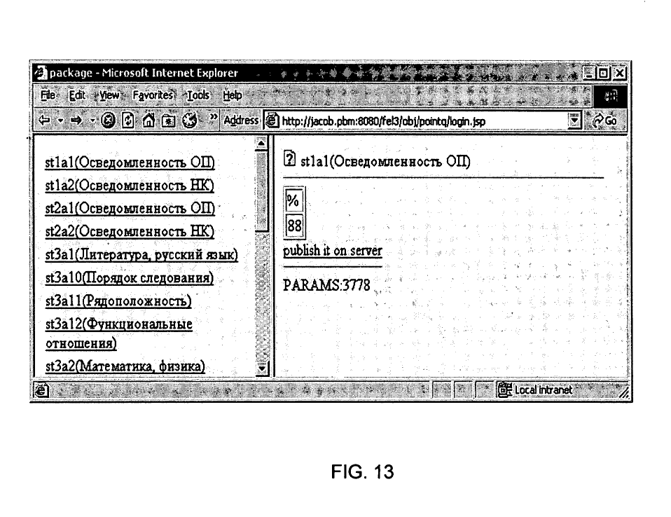

FIG. 14 illustrates JSP-pages and an entry folder;

FIG. 15 presents Java-classes;

FIG. 16 illustrates data base structure (tables);

FIG. 17 shows the main tables: OBJECT;

FIG. 18 illustrates the main tables: TYPE;

FIG. 19 presents an example of type tables: QUERY.

### DETAILED DESCRIPTION OF THE INVENTION

Given below is a list of definitions from the art or partially new or new that are used when describing the present invention.

Known Definitions

Object—a minimal logical unit of data. Documents, events, facts, real things, business factors, people, users, procedures, etc. are represented in the EIS as objects.

Data elements—a minimal stored unit of data. Numbers, strings, date or time values, Boolean values, key values, files (pictures, documents) can be data elements of some objects. Data element in the object has a name (that is common for all objects of the type) and value (that is specific for the object). The name complies with column names' restrictions of the DMBS used for fields and keys and complies with file names' restrictions of the operating system used. The system can keep other names for the data elements (hereinafter called demonstrated names) to show them instead whenever it is possible.

Operations—actions such as delete, move, etc., that can be done with almost any object.

Functions—some functions could be executed on objects of some types.

Shortcuts (or shadows) of some originals are like in file systems as Windows. Shadow keeps some additional data hereinafter called shadow data.

Partially New Definitions

All objects form one Object Tree. It looks like a file system in an operating system such as Windows. In Object Tree, however, a node of any type can be placed under a node of any type, whereas in Windows nodes can be placed under folders, not under files.

Type is like a class in Java or C++ but there are some important differences. First, every object has a type-set and a type-center that is an element of the set. Type-set defines what object keeps. Type-center (or type) defines how object behaves. Behavior includes a list of data elements to be demonstrated and a list of functions to be executed. Second, type-center or type-set can be changed for the object during its life time.

Types can be inherited like classes in Java. Types form one Inheritance Tree. If type A is inherited from type B, it means that a list of data elements of a B-type object is an initial part of a list of data elements of a A-type object and a list of functions of a B-type object is an initial part of a list of functions of a A-type object.

Multiple inheritance is allowed much as in C++. To define that type A is inherited from B, C, D etc., the shadow of node A is put under nodes B, C, D, etc. For implementing multiple inheritance, it is allowed to add tags of nodes (shortcuts to originals) to the inheritance tree. A complete list of data elements (or, respectively, a complete list of functions) is made by uniting all the lists over all the paths from the InhT root to a given type (node), one (the only, main) path comprising no tags, the remaining (additional, possible) paths passing through tags. In arranging a path, the tag is replaced by its original. Nothing is allowed to be put under a tag.

Abstract types, like abstract classes in Java, have no objects. But unlike Java, they cannot add data elements or new functions along the path of InhT. They serve to conveniently group nodes in the InhT.

New Definitions

Creation of a new object A under a finished type-B object is somewhat limited. To describe this limitation, an Including Tree has been introduced. All types (excluding abstract types) form one Including Tree that defines the rules of limitations. An object of type A can only be created under an object of type B if A is under B in the Including Tree. Multiple including is allowed. For that, node tags are added to the Including Tree. Now, to create a type-A object under a B-type object, it is sufficient that type A or one of its tags be under type B in the Including Tree. Nothing is allowed to be put under a tag, type FOLDER being a special case, with objects of this type allowed to be created under any node.

Since a user is an object, a sub-tree starting from this object as a root can be defined, the sub-tree being hereinafter referred to as a responsibility zone of the user. It is from this sub-tree that the user sees the object tree when he/she logs in. The user has all the rights conceivable over the objects in this zone, moving, changing or deleting being the examples thereof. To prevent the sub-tree from being lost in the object tree, a user's code cannot be changed.

Viewing Tree is made from Object Tree when shadows are added under some objects. Responsibility zone includes such shadows added under object of responsibility zone. User can move or delete such shadow or change its shadow data. Pseudo-nodes are added under such shadows for every descendant of the original of the shadow. This tree can be infinitive though Object Tree cannot.

User's Viewing Zone includes objects, which he/she sees and which the user can run functions on directly or through shadows and pseudo-nodes. The Viewing zone is a maximal sub-tree of Viewing Tree starting from the user as a root. This zone is wider than a responsibility zone. If an object entered the Viewing zone but did not enter the Responsibility zone, the user cannot change (delete, move) this object. To define the Viewing zone, tags are allowed to be added at the nodes in the ObT. (Nothing can be added under the tags.) If a tag is added to an object A under the responsibility zone, the user sees the object A, as well as all the objects that are lower in the ObT. If it is a tag that was found lower, the user sees its original, and so on. The viewing zone can be an infinite tree, though the whole object tree and any responsibility zone are always finite. It is allowed to store shadow data in a tag. Upon reviewing the viewing zone, the shadow data eclipse similar data elements of the original. The user can remove the tag added under his responsibility zone, move it, change its shadow data.

A Competence zone contains those, and those only, types that are type-centers of objects from his/her responsibility zone. User can change type-set of an object if, and only if, the object is in his/her responsibility zone and his/her competence zone does not expand upon the change.

A Root of Inheritance Tree and a Root of Including Tree is the same node hereinafter referred to as OBJECT. The Root of Object Tree has OBJECT as its type-center. The latter root is for a special user that has all objects in his/her responsibility zone, sees the whole object tree and therefore is a System Administrator. This user is the only one who can change Including Tree or Inheritance Tree and their nodes as a System Architect.

Structure of the System

Generally, an enterprise management is organized as a hierarchy. Users must be placed into the Object Tree accordingly. Then a responsibility zone of the chief will include responsibility zones of subordinates. Every object will be in the responsibility zone of at least one user. If an object is in the responsibility zones of several users and they are arranged hierarchically, it is easy to understand what user is responsible for a given object in the first place, who is the next one responsible in the case the first user is “out of the office,” who is the next one responsible in the case the first two users are “out of the office,” etc. In the end, it is a data system administrator who can never be “out of the office.” When an employee participates in a number of projects, it is reasonable to provide himn/her with a user object for every project. When working on a specific project, he/she has to be a user for this project.

Kept under each user object in his/her responsibility zone are the objects, which the user is responsible for in real work, whose meaning is understandable for the user, and the correctness of the data thereabout the user can guarantee in substance. The situation like this is substantially better than that in known systems where one employee would fill in a paper data form not seeing a computer and thus not responsible for the correctness of entering the data into the computer, and another employee who would enter the data but would not be able to assess it substantially and thus would not be responsible for correctness of the data being entered. The access control system according to the present invention provides such advantages as simplicity, transparency, distributed control, and completeness and consistency of responsibility for data and structures.

With this access control system the quality of EIS, including user's comfort and data quality, will be better than the quality of the systems known in the art. Low cost of small changes allows developing EIS from scratch that means affordability. An administrator-architect using tools flexible enough to implement any task guarantees unity of EIS that must replace all other subsystems and include all the data step by step.

System Growth

In 95% of all cases, the growth of the system, which is described herein in accordance with the present invention, can be fulfilled by its administrator-architect, rather than a programmer, using conventional system operations (adding new types, changing existing types, changing Inheritance Tree and Including Tree, etc.). About 4% of all cases of the growth can be done using SQL coding. Objects of a QUERY type can execute SQL-statements on a database provided the statement has been entered in a respective data element. There is also an SQL-generator to help write the SQL-statement proposing tables, columns etc. And about 1% of all cases with regard to system growth demands Java coding. The above 5% (4% and 1%) can be conveniently realized by outsourcing at an external entity supposed to accompany the system environment. The architect is the only person at the enterprise responsible for the system as a whole and its functioning and growth, and this person is not supposed to be a programmer.

Using DBMS Standard Features

According to SQL-92 standard, relational DBMSs possess the following particular features useful for the system of the present invention, the definitions thereof being narrowed to the extent necessary for implementing the EIS in question.

(1) A field of a table can be defined as PRIMARY KEY.

(2) A field of a table can be defined as FOREIGN KEY referencing to another (or to the same) table (to its primary key). No record can be inserted to the former table unless a corresponding record (with a primary key value equal to a foreign key value) exists in the latter table.

(3) If the foreign key is defined with option ON DELETE CASCADE, then upon deleting the referenced record DBMS deletes all the referencing records.

(4) If the foreign key has no option ON DELETE, DBMS prevents the referenced record from deleting if at least one referencing record exists.

The above feature (2) can guarantee the automatic realization of the following rules: (2.1) An object can only be created if there already exists a corresponding type of the object; (2.2) A record can only be inserted into a type table if a proper object for the record exists; (2.3) A tag can only be created if a respective original exists.

The above feature (3) can guarantee the automatic realization of the following rules: (3.1) Upon deleting a node, the whole sub-tree from the node as a root is to be deleted; (3.2) Upon deleting an object from the OBJECT table, all the records for this object have to be deleted from all the type tables; (3.3) Upon deleting an original, all its shadows are to be deleted.

The above feature (4) can guarantee the automatic realization of the following rules: (4.1) No type can be deleted if there exists even one object of the type; (4.2) The object referenced by at least one other object cannot be deleted.

Achieving Claimed Results

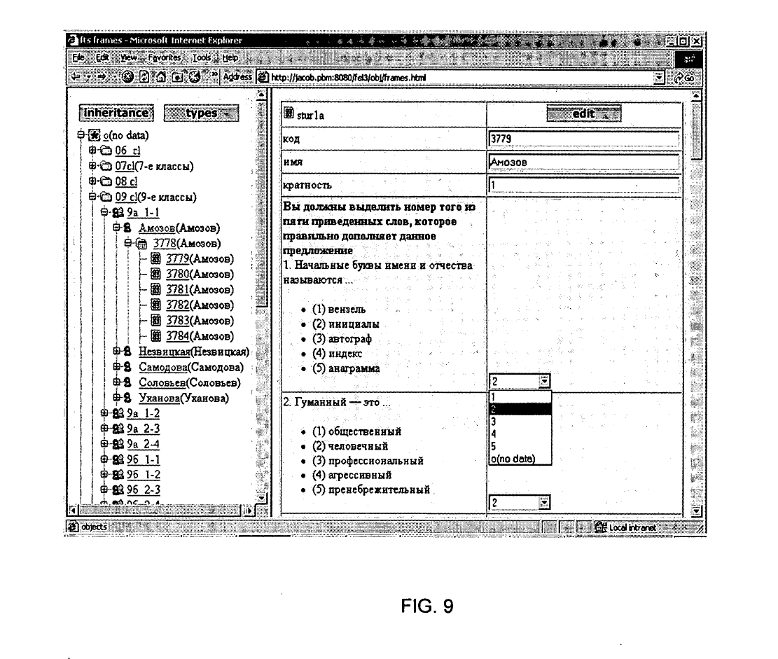

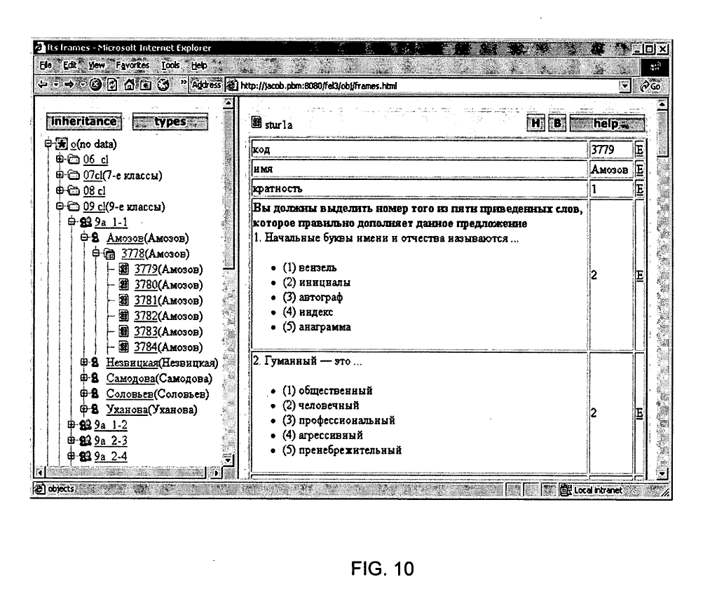

Affordability is achieved by (a) providing a limited number of specialists for developing and growing the system, (b) their relatively low qualification, (c) a small extent of a single change (one type), and (d) automatic updating main input and output forms upon changing a type (that can be seen in FIGS. 9, 10).

Unity is achieved by flexibility of a data model, including inheritance (simple or multiple); splitting type into type-set and type-center, both being allowed to be performed during the lifetime of the object; adding SQL-queries and Java-functions; the possibility to store at an object pictures and files of arbitrary formats as data elements, as well as keys referencing to types, all the above allowing the implementation of all the tasks of the enterprise in a single informational space replacing all the subsystems necessary and including all the data required.

Quality is achieved by providing a hierarchical access control system that guarantees quality of the information processed. There is no data beyond someone's responsibility therefor. Responsibility in the EIS coincides with responsibility at the enterprise, therefore it is easy to locate a person responsible for a given object. The system is flexible, natural, and controllable. Viewing objects and responsibility therefor are separated. Creation of objects is limited with Including Tree. Multiple including is allowed. The type of an object is changeable (type-set as well as type-center), this being limited within a competence zone. Shadow data are allowed. The ease of changing data structures (on Inheritance Tree, Including Tree, object types) allows for fine adjusting the system to the problems to be solved, on one hand, and to system users, on the other. Abstract types conveniently allow arranging the Inheritance Tree.

The Principles of the Realization of the System

Reliability and effectiveness. Taking in account reliability and effectiveness, the system of the present invention is implemented in a “client—server” architecture using Java language and JSP web technology. The current realization is based on Java SDK 1.5, J2EE 1.3 (available for free for downloading from the Internet).

Affordability. The best environment to implement in is believed to be Windows 2000 as an operating system and MS Internet Explorer 5.5-6.x as a client.

Free tools. Apache Tomcat 5.5 (from a Jakarta project) is used as a web server. For a file loading function, the File Upload library of the Jakarta project is used. For DBMS, a Mckoi system is used (version 1.0.3). NetBeans 4.0 of project NetBeans.org is used as an IDE. WinRar software is used for data compression and extraction. All the above tools are available for free from the Internet.

### The Order of Work

Installation and Start

It is supposed that none of the software systems listed below was installed on a given computer prior to this installation.

(1) Installing Java SDK 1.5.

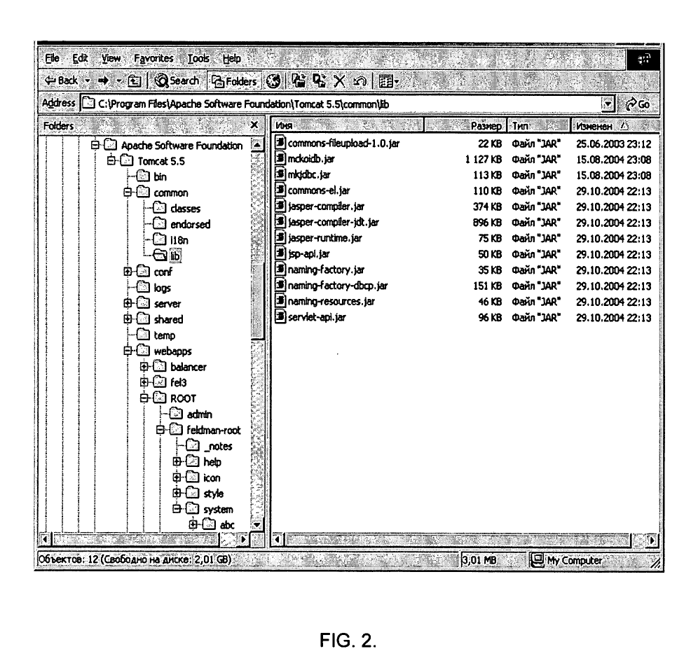

(2) Installing Apache Tomcat 5.5. Check “as NT service” is recommended (FIG. 2).

(3) Copying the following libraries into /common/lib folder under server (FIG. 2) a. mckoidb.jar, mkjdbc.jar as DBMS b. commons-fileupload.1.0.jar for file loading function.

(4) Copying software hereinafter referred to as FTS (fel3.rar) into/webapps folder under server and extracting it (FIG. 2).

(5) Copying entry package (feldman-root.rar) into/ROOT folder under server and extracting it (FIG. 2).

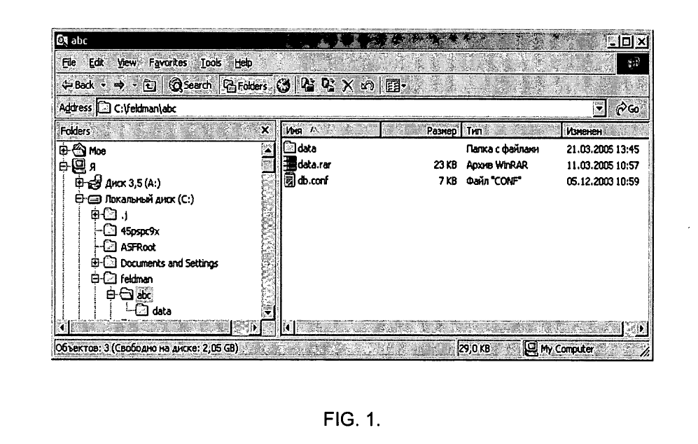

(6) Copying database archive (data.rar) into /feldman/abc folder and extracting it (FIG. 1).

(7) Copying database configuration file (db.conf) to the same folder (FIG. 1).

(8) Editing entry files (index.htm, index2.htm, index3.htm, index4.htm, index5.html) from the entry package (see (5) in [0089]) so as to have form parameters corresponding to a physical location of the server (see (2) in [0086]), to the data base configuration file (see (7) in [0091]), and schema name “abc” (see (6) in [0090]).

(9) Starting Apache Tomcat server.

(10) Opening browser with address of entry file index.html (see (8) in [0092]).

(11) Logging in, starting working.

Changing a Version

(1) Stopping the Apache Tomcat server.

(2) Deleting folder fel3 and fel3.rar archive (see (4) at [0088]) in the installation process.

(3) Copying a new version of fel3.rar instead and extracting it.

(4) Starting Apache Tomcat server.

(5) Continuing working.

Changing the style. Background color and button outlook depend on the /feldman-root/style folder (see (5) in [0089]). It could be replaced anytime.

Data Backup

(1) Stopping the Apache Tomcat server.

(2) Compressing /data folder into data.rar (see (6) in [0090]).

(3) Copying data.rar aside.

(4) Starting the Apache Tomcat server.

(5) Continuing working.

Restoring Data

(1) Stopping the Apache Tomcat server.

(2) Deleting /data folder and data.rar (see data backup above).

(3) Copying reserved data.rar instead and extracting it.

(4) Starting the Apache Tomcat server.

(5) Continuing working.

### Interface

Personal User Interface

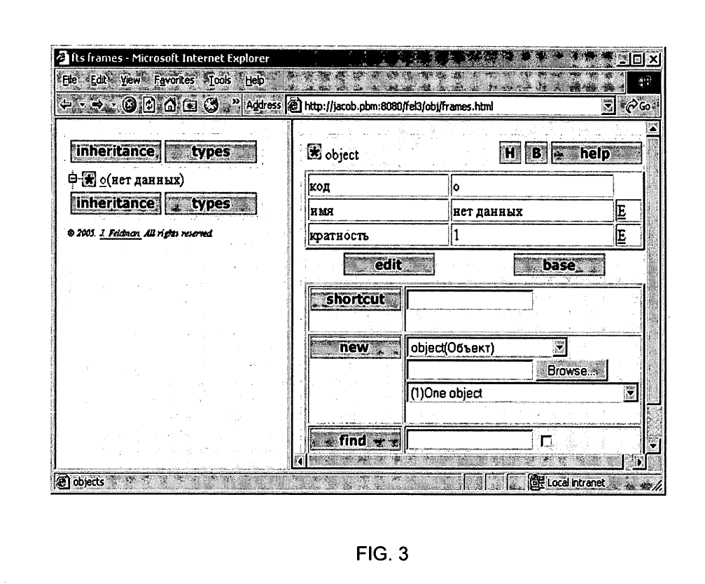

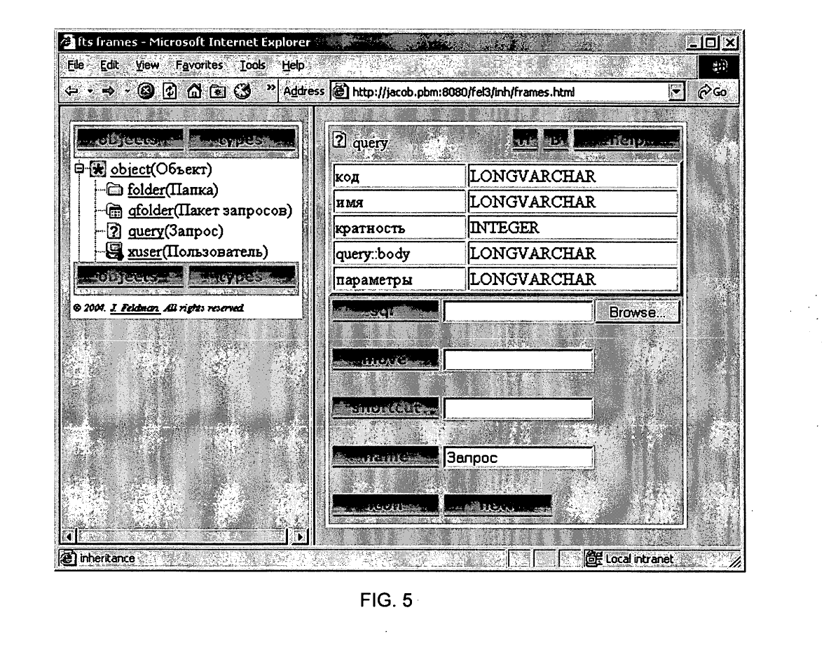

For a personal user, the system can be in the following states: Objects (Object Tree, FIG. 3), Types (Including Tree, FIG. $), and Inheritance (Inheritance Tree, FIG. 5). Both the background color and status line at the bottom show the state.

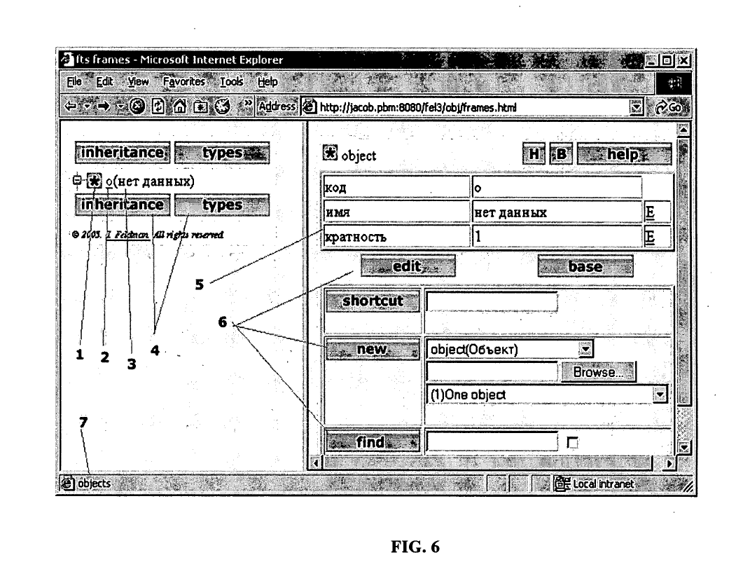

Left side. Tree for the state given is shown on the left (FIG. 6). Shown there are icons 1 of type, codes 2 of the node, name 3 of the node, buttons 4 to change the state. The code 2 of the node has a link to an open node on the right (FIG. 6).

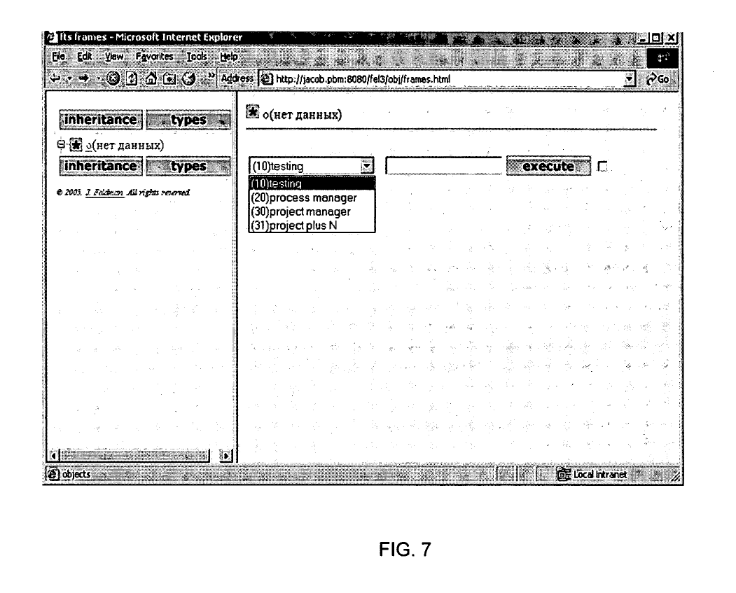

Right side. Data elements 5 and operation buttons 6 for the node are shown on the right (FIG. 6). If the node has functions, the icon 1 in the tree has a link to an open function list on the right (FIG. 7).

Anonymous User Interface

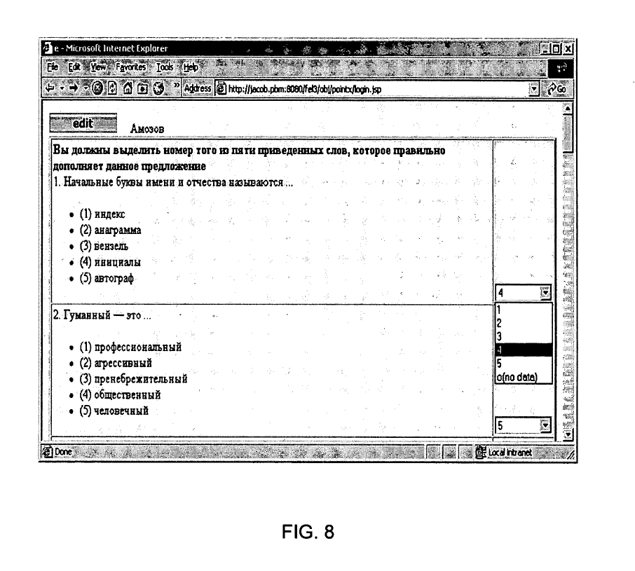

Student's point interface. Type ID and code of the node to log in and get the node data elements to edit (FIG. 8, 9, 10). Storing only is available for the user. Only end type table columns of the inheritance chain are under control here. There is no timeout provided.

Analyst's point interface. This case is the same as a previous one with the exception that the user gets functions' list of a given node (instead of data elements' list in the previous case). The function code and arguments' string are next input elements of the entry form after ID and code of the node.

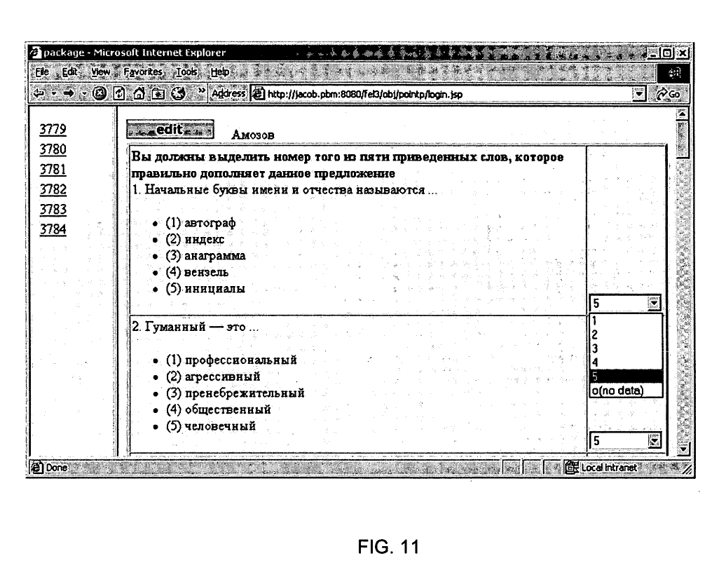

Student's package interface. It shows a list of codes of the nodes on the left and opens the node of the right when the user clicks the code (FIG. 11). The list presents children of the node defined in the login page. The right part is the same as in the student's point interface.

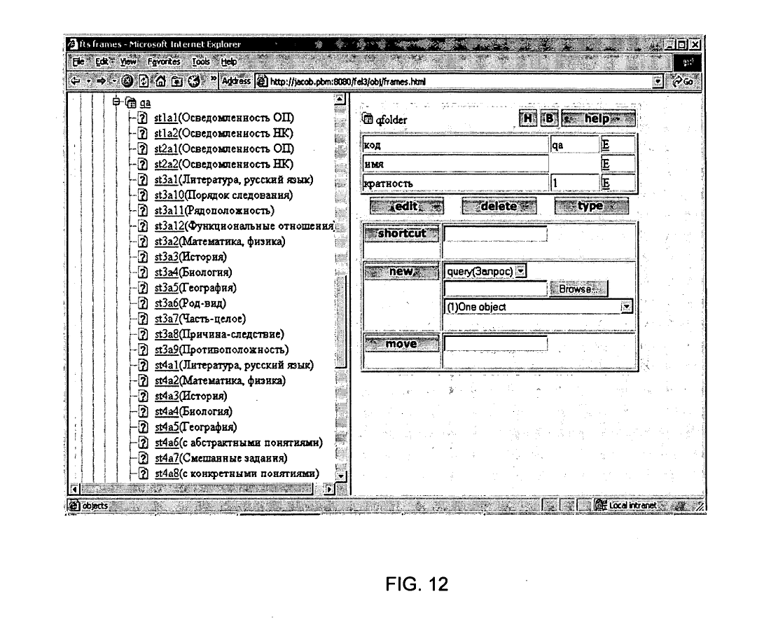

Analyst's package interface. It is the same as in [0117] but shows nodes that are queries to run on the given node (FIG. 12).

### Code Architecture

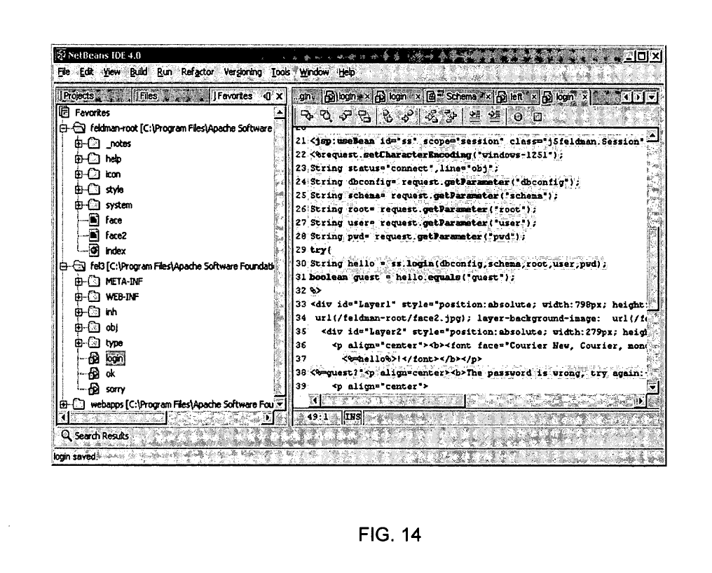

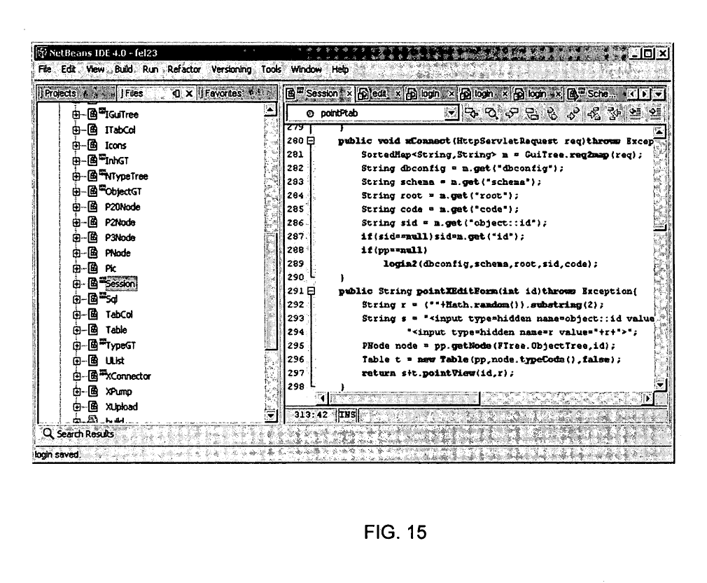

The software consists of the following three parts: Java—classes (FIG. 15), Java Server Pages (FIG. 14), and an entry package with html-pages and images (buttons, backgrounds etc) (FIG. 2).

### Data Structure

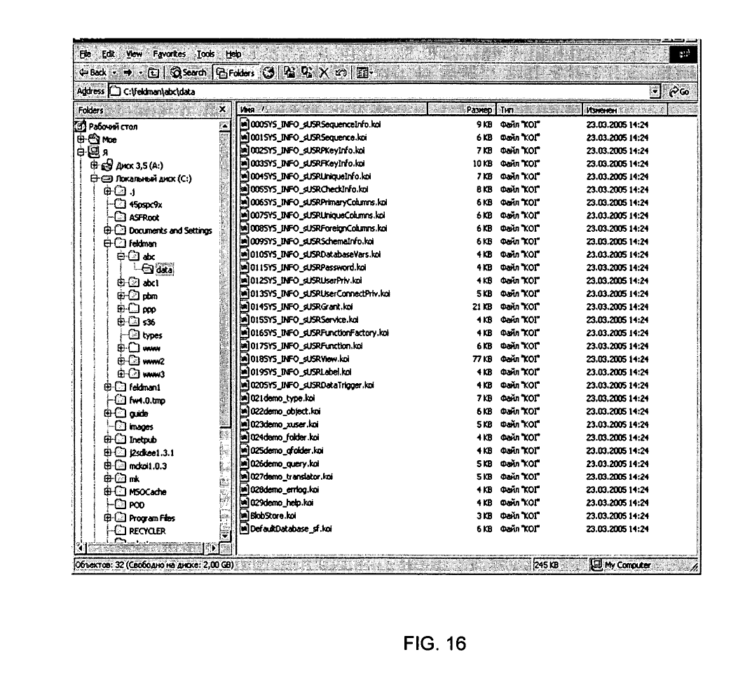

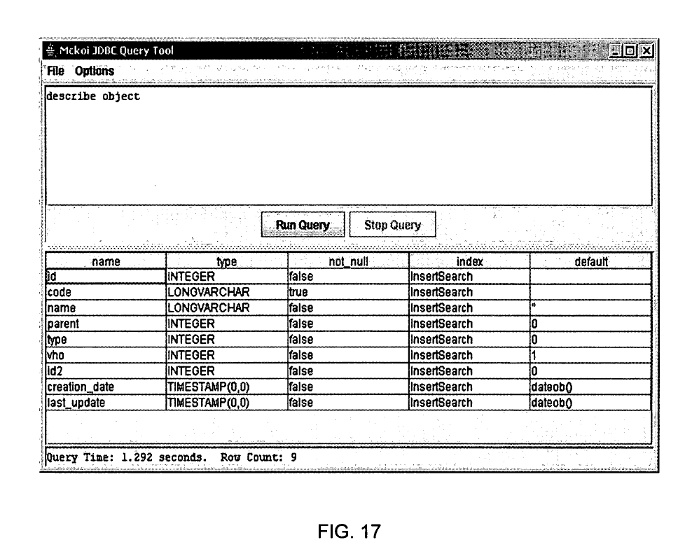

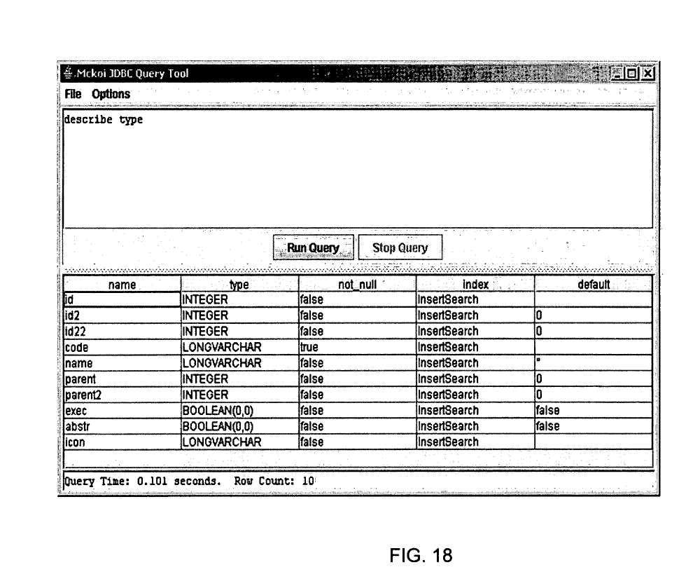

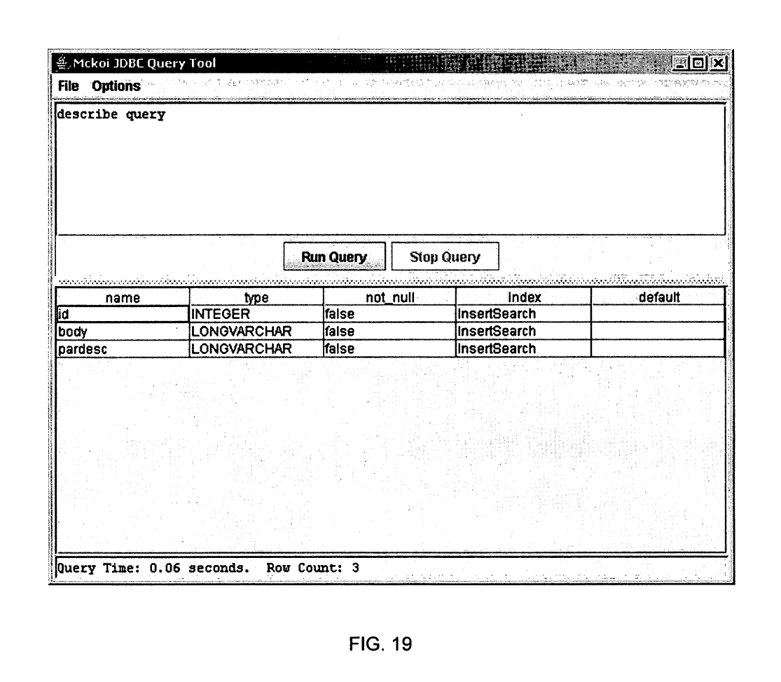

The structures are shown in FIGS. 16, 17, 18, and 19.

While the present invention has been described referencing the illustrated and above enumerated embodiments, the present invention is not limited to these described embodiments. Numerous modification and alterations may be made, consistent with the scope of the present invention as set forth in the claims to follow. Thus, the above-described embodiments are merely illustrative, and not restrictive on the present invention.

What is claimed is:

1. An Information System, in which information is organized in logically independent units (objects) working over a net in a client-server architecture with file system or database management system or integrated development environment, wherein the users are objects and all objects form an Object Tree, relations between users in the tree are arranged similarly to the relations between corresponding coworkers at the enterprise, maximal sub-tree of the Object Tree from the user as the root forms a first responsibility zone of the user, and the user can delete or change or move object only if it is in the user's first responsibility zone.

2. The system of claim 1, wherein possible contents of the object is defined with a type-set of the object, and behavior of the object including data demonstration and functions to run on the object is defined by a type-center element of the set, all types forming an Inheritance Tree, and if some node A is in this tree the parent of some node B, then data elements' list and functions' list of objects of type A form start part of data elements' list and functions' list of objects of type B accordingly, and any sub-tree of Inheritance Tree that contains its root could be a type-set.

3. The system of claim 2, wherein all said types form one Including Tree and user can create new object of type A under object of type B if and only if (a) the object of type B is in the user's first responsibility zone and (b) the node B is a parent of the node A in Including Tree or A is a special type, or FOLDER.

4. The system of claim 3, wherein a root of the Object Tree is for a super-user responsible for all the data (as Administrator) and all system development (as Architect), and said type of the root (hereinafter called O) is the root of said Including Tree and said Inheritance Tree (hereinafter called OBJECT), and only said Architect can change said Including Tree and said Inheritance Tree and their nodes, and said type-center of some object equals said OBJECT type if and only if the object is said root of said Object Tree, and said objects have unique numbers (INTEGER) and said types have unique numbers (INTEGER) and said roots of said Object Tree and said Including Tree and said Inheritance Tree have 0 as a number.

5. The system of claim 1, wherein for every node as an original, but the root of said Object Tree, a shortcut (a shadow) is created, and every shadow keeps defined data elements (the same for the system) as additional shadow data, and said Objects Tree along with shadows added under some objects as children form an Object and Shadow Tree, and a second responsibility zone in said Object and Shadow Tree is said first responsibility zone in said Object Tree with said shadows added under objects in the first responsibility zone, and said user can move or delete shadows or change shadow data only in the second responsibility zone.

6. The system of claim 5, wherein a Viewing Tree is built from said Object and Shadow Tree as follows:
a. for every shadow the original node is found
b. for said original all descendants are found
c. for each of said descendant (as original) a new pseudo-node is created, and
d. said pseudo-node is added under said shadow or another pseudo-node according relations of said originals,
pseudo-nodes and shadows taking their type-sets and type-centers from the originals, and
Viewing Zone is defined as maximal sub-tree of said Viewing Tree that starts from this user as a root, and
said user can run all functions on every shadows and pseudo-nodes of said viewing zone in the same way as on their originals, and
said user can see all data elements of the originals excluding the case of shadow data that shield (replace) for the user data elements of originals with the same names, and
said user can create a shadow from any node of the viewing zone and put it under some object in responsibility zone and said shadow takes its origin from said node (if it is not object), and
said shadows and pseudo-nodes are marked in the interface with special style (italic, for example).

7. The system of claim 2, wherein a Competence Zone is defined as a minimal sub-tree of Inheritance Tree that includes (as a sub-sets) all type-sets of said nodes of said first responsibility zone, and
said user can change type center of any object in said first responsibility zone if only it stays inside the said type-set, and
said user can change type-set of any object in said first responsibility zone if only it does not expand user's said competence zone.

8. The system of claim 4, wherein said objects are implemented as records in tables of a relational DBMS, and
every said type has its table with name like its own, and
there is table TYPE that contains one and only one record for every type, and
the column CODE in table TYPE contains table for type name and column ID contains type number, and
said table for types and table TYPE are hereinafter called type-tables, and
every said type-table has a column hereinafter called ID for object number (type number for TYPE) as PRIMARY KEY, and
in every said type-table (besides OBJECT and TYPE) said ID is declared as FOREIGN KEY referencing one of such tables with option ON DELETE CASCADE
in table OBJECT column TYPE is declared as FOREIGN KEY referencing table TYPE without option ON DELETE CASCADE

9. The system of claim 8, wherein said type-set of the object is defined by presence of records with ID given in said type-tables, and
said presence of said record for the object in one type-table implies said presence of said record of the object in all tables of types that are nodes of said Inheritance Tree from said type to the root including, and
when moving node in said Inheritance Tree every object that contains this node in the type-set gets new record into every type-table on the path (in said Inheritance Tree) between this type node and OBJECT if there is no record in this table for this object yet.

10. The system of claim 8, wherein additional columns of said type-tables are declared as FOREIGN KEY if:
a) the column is INTEGER and
b) the key references only PRIMARY KEY of some type-table (that means ID) without the ON DELETE CASCADE option and
c) whenever the key value is about to set it is selected from a drop-down list filled with all objects that contain the type referenced in the type-set.

11. The system of claim 1, wherein any object contains data elements that are files of any format, and
said user can load said files from client to server machine or delete said files from the server if and only if said object is in said first responsibility zone, and
presence of a file as a data element in said object is defined by the presence of a path in the file system of a “type name/file name/extension” type, and
said file has a name of a “object number.extension” type.

12. The system of claim 11, wherein files-pictures are demonstrated immediately with data elements as fields and keys, whereas files-documents are demonstrated on demand, for example after an additional click, and said pictures and said documents are stored in file system in parallel starting from different start directories.

13. The system of claim 8, wherein the structure of said Object Tree is stored in said table OBJECT in column PARENT, and structures of said Including Tree and said Inheritance Tree are stored in said table TYPE in columns PARENT and PARENT2 accordingly, and
said columns store said number (ID value) of parent node and are FOREIGN KEYS referencing the same table with option ON DELETE CASCADE.

14. The system of claim 13, wherein shadows for every node (excluding the root) are allowed in said Including Tree and said Inheritance Tree and can be placed under not shadow nodes only, and
to allow creation of object of type A under objects of type B, C, D, etc create shadows of type A (as origin) and put A under B in said Including Tree and shadows of A under C, D, etc. accordingly, and
to describe multiple inheritance of type A from types B, C, D, etc create shadows of type A (as origin) and put A under B in said Inheritance Tree and shadows of A under C, D, etc accordingly, and
said shadows are stored in the same tables as origins (OBJECT, TYPE) and a column ID2 (ID22 for said Inheritance Tree) is FOREIGN KEY with option ON DELETE CASCADE referencing the same table pointing to the origin, and
said column equals 0 if and only if it is not shadow node.

15. The system of claim 8, wherein abstract types are allowed that appear in said Inheritance Tree and serve to store some nodes of said Inheritance Tree under one node-parent.
